(19) United States
(12) Patent Application Publication
(10) Pub. No.: US 2012/0032601 A1
(43) Pub. Date: Feb. 9, 2012

(54) SYSTEM FOR CONTROLLING A PLURALITY OF LIGHT SOURCES

(75) Inventors: Matthias Wendt, Wurselen (DE); Peter Fuhrmann, Aachen (DE); Peter Luerkens, Aachen (DE); Oliver Schreyer, Herzogenrath (DE); Maurice Herman Johan Draaijer, Ittervoort (NL)

(73) Assignee: KONINKLIJKE PHILIPS ELECTRONICS N.V., EINDHOVEN (NL)

(21) Appl. No.: 13/265,094

(22) PCT Filed: Apr. 15, 2010
(86) PCT No.: PCT/IB2010/051638

§ 371 Date: Oct. 19, 2011

(30) Foreign Application Priority Data
Apr. 24, 2009 (EP) 09158677.6

(51) Int. Cl. H05B 37/02

(52) U.S. Cl. 315/154

(57) ABSTRACT

A system (100) for controlling a plurality of light sources (104a-f) by means of light groups, wherein each light group synchronously controls a subset of the plurality of light sources. The system (100) comprises: a central controller (102); a plurality of light sources (104a-f) wired to the central controller (102); and a light sensor (106a-c) wired to the central controller (102). The central controller (102) is configured to: receive a measurement signal from the light sensor; based on the received measurement signal, determine a subset of light sources that are in optical contact with the light sensor; and include the subset of light sources in a light group associated with the light sensor.

### TECHNICAL FIELD

The present invention relates to a system for controlling a plurality of light sources by means of a central controller.

### BACKGROUND OF THE INVENTION

Lighting control systems can be utilized to control luminaires in environments such as offices, schools, or hospitals. An example of a lighting control system is LightMaster Modular from Philips. The LightMaster Modular is a “building block” concept where light sources, manual switches, movement detectors, and light sensors can be plugged in to a central controller arranged to control the illumination. Another example of a lighting control system is disclosed in WO 2007/095740, where a light source and a remote detection unit are connected to a controller over a wired network.

To enable efficient illumination control it is often desirable to create light groups, wherein each light group includes a subset of luminaires that may be synchronously controlled. For example, all light sources in a specific room, or a part thereof, may form a light group. Thus, as a movement detector registers the presence of a person in that specific room, the central controller can respond by switching on the luminaires in that room. In a conventional lighting control system, the light groups are typically fixed by wiring or set by explicit programming of the controller. However, this may often be a time consuming and unflexible procedure. Thus, there is a need for a more flexible solution, especially when room usage and/or room separation is frequently changed.

### SUMMARY OF THE INVENTION

In view of the above, an object of the invention is to at least alleviate the problems discussed above. In particular, an object is to provide a lighting control system that automatically groups light sources that are to be synchronously controlled.

According to an aspect of the invention, there is provided a system for controlling a plurality of light sources by means of light groups, wherein each light group synchronously controls a subset of the plurality of light sources, the system comprising: a central controller; a plurality of light sources wired to the central controller; and a light sensor wired to the central controller. The central controller is configured to: receive a measurement signal from the light sensor; based on the received measurement signal, determine a subset of light sources that are in optical contact with the light sensor; and include the subset of light sources in a light group associated with the light sensor. By optical contact should here be understood that the light sensor registers light emitted by the light source.

The present invention is based on the understanding that light sources that are to be synchronously controlled typically tend to be the ones that can be simultaneously perceived by a person. The inventors have further realized that, since the perceived light sources are the light sources that are in optical contact with the person, they will also be in optical contact with an appropriately located light sensor. Thus, a convenient way to identify a subset of light sources that are to be synchronously controlled is to utilize a light sensor.

The subset of light sources may include all light sources that are in optical contact with the light sensor. As a result, the resulting light groups will typically correspond to a room or some other more or less secluded area suitable for synchronous illumination control.

Furthermore, the central controller may be configured to identify a specific light source by a light property of the light emitted by that specific light source. The light property may be a variation in light intensity. An advantage herewith is that the light intensity can be measured by means of a conventional light flux sensor thereby enabling a cost efficient solution.

Further, the central controller may be configured to switch on and off the light source to achieve said variation in light intensity.

According to an embodiment, the central controller may be configured to sequentially switch on and off each light source, while the other light sources remains switched off. This enables a simple and cost efficient way to be able to identify individual light sources.

According to another embodiment, the central controller may be configured to identify individual light sources by means of intensity modulation. An advantage associated herewith is that a specific light source can be identified also when multiple light sources are switched on at the same time.

According to an embodiment of the invention, the subset of light sources may only include light sources of a specific type. An advantage is that the central controller may create a light group that is restricted to one or more specific type(s) of light source. The central controller may then automatically allocate an appropriate set of pre-programmed instructions (e.g. how it should react on presence detection and how long the presence delay should be) to the light group. Furthermore, the central controller may be configured to identify a specific type of light source by means of at least one light property selected from the group of spectral contribution, colour, or white point. Examples of different types of light sources are HID based lamps, halogen based lamps, and fluorescent tubular lamps. This aspect of the invention, i.e. to identify and group light sources based on type, may be advantageously applied independently of other aspects. For example, it is not limited to a central controller having a light sensor and light sources that are directly attached by wires, but may also be utilized e.g. for a system with wireless connections and/or for a system having a controller connected to the light sensor and light sources over various types of networks.

According to an embodiment, the light sensor and a triggering device may be arranged in a combined housing. Furthermore, the light sensor and the triggering device may be connected to the central controller by a common (i.e. the same) wire. The wire may also have a single plug that connects both the light sensor and the triggering device to the central controller. An advantage is that there is an inherent relationship between the light sensor and the triggering device.

A triggering device here refers to a device arranged to trigger activation of a light group, such as, for example, a manual switch (that can be operated by a user) or a movement detector. However, a light sensor may also trigger activation of a light group, e.g. if a room requires that some light sources are switched on whenever daylight gets insufficient no matter whether there are any person present (this may e.g. be a requirement for corridors, halls or the building entrance area).

The central controller may be configured to automatically trigger a procedure for creating light groups at a predetermined occasion. The at least one predetermined occasion may be during start-up of a newly installed system or at regular intervals (e.g. that the procedure is triggered each night).

The procedure for creating light groups may preferably be triggered only when a light level registered by the light sensor is below a predetermined to avoid saturation of the light sensor and thereby providing enhanced accuracy. Furthermore, the procedure for creating light groups may preferably be triggered only when no presence of a person has been detected by the movement detector during a predetermined time (e.g. one hour).

According to an embodiment, the central controller may have a pre-programmed default light group that includes all light sources that are connected the central controller. The default light group may be useful, for example, for a newly installed system where the procedure for creating light groups has not yet been run, or if the procedure for detecting light groups is not successful.

Other objectives, features and advantages will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 schematically illustrates a lighting control system according to an embodiment of the invention.

FIG. 2 schematically illustrates the lighting control system in FIG. 1 installed in an environment with three rooms.

FIG. 3 is a schematic block diagram illustrating a procedure for creating light groups according to an embodiment of the invention.

FIG. 4 schematically illustrates the lighting control system in FIG. 1 installed in a room that can be divided into two separate rooms by means of a movable partition wall.

FIG. 5 is a schematic block diagram illustrating a procedure for detecting whether a partition wall is open or closed.

### DETAILED DESCRIPTION OF PREFERRED EMBODIMENTS

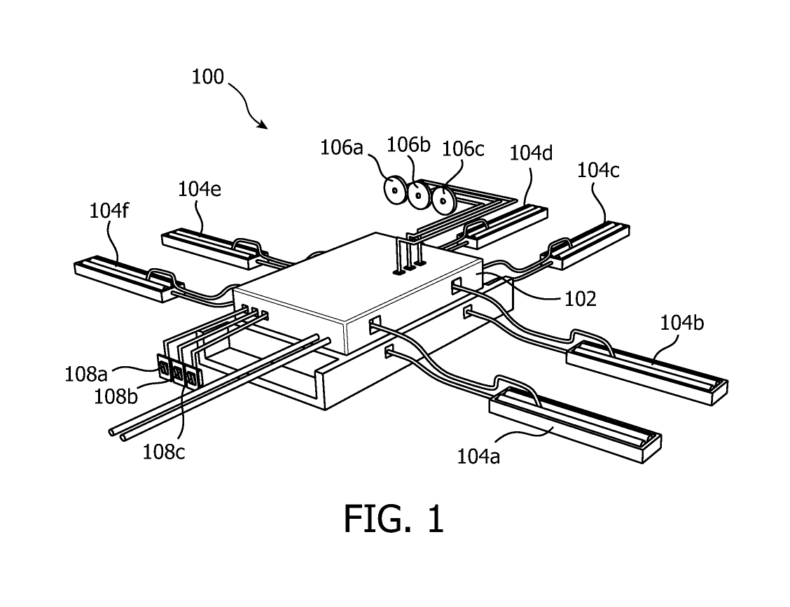

FIG. 1 schematically illustrates a lighting control system 100 according to an embodiment of the invention.

The lighting control system 100 includes a central controller 102, a plurality of light sources 104a-f, a set of light sensors 106a-c and a set of triggering devices 108a-c. The light sources 104 may be conventional luminaires, such as e.g. HID based lamps, halogen based lamps and/or fluorescent tubular lamps. The light sensors 106 a-c are here light flux sensors for measuring light intensity. However, other more sophisticated light sensors may also be used to be able to measure other light properties. The triggering devices 108a-c may e.g. be movement detectors or manual switches that can be operated by a user. The light sources 104a-f, light sensors 106a-c, and triggering devices 108a-c are directly attached to the central controller 102 by wired connections. Furthermore, the central controller 102 has a processing unit, and software for controlling the illumination. The central controller may also be connected to a user interface (not shown) to enable explicit programming by a user. Furthermore, the central controller 102 can switch each light source totally off by means of a relay or semiconductor switch, thereby enabling the standby power consumption to be reduced.

To enable synchronous control of multiple light sources, the light sources can be arranged into light groups including a subset of light sources. Information about which light sources belongs to a specific light group is stored in the memory of the central controller.

The procedure of creating light groups is often referred to as a commissioning procedure and can be done manually by fixed wiring or by explicit programming of the central controller. The commissioning procedure may also be automatic. Such an automatic commissioning procedure may be triggered manually, or automatically. For example auto-commissioning may be automatically triggered during a system start-up, and/or at regular intervals, e.g. every day or every week. Preferably the auto-commissioning is triggered when no person has been detected by the movement detectors for a defined time (e.g. one hour) and the light sensors detects a light level below a preset threshold (guaranteeing for sufficiently low daylight level).

There may also be a switch on the central controller to suppress auto commissioning for a freshly installed system. To avoid a situation where the central controller does not know any relations between triggering devices and light sources there may be a default light group. The default light group includes all light sources connected to the central controller and can be operated by any of the available trigger devices. The default light group can thus be used until a commissioning is done.

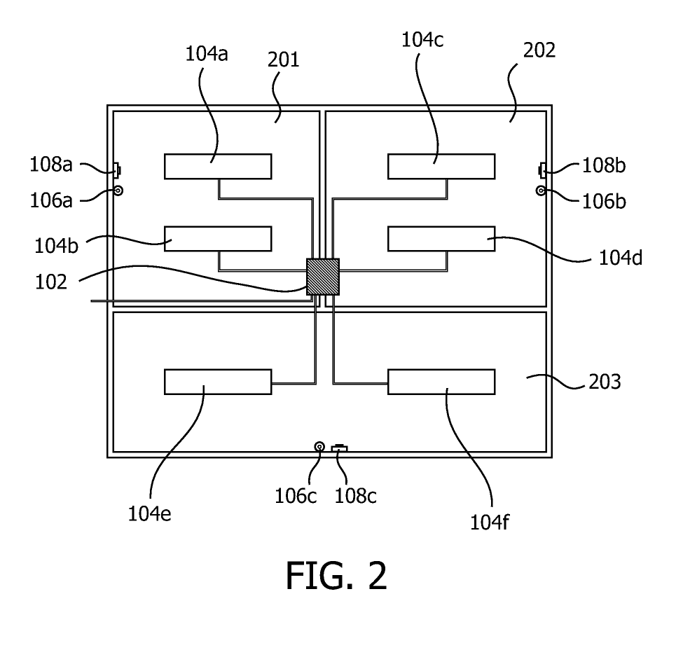

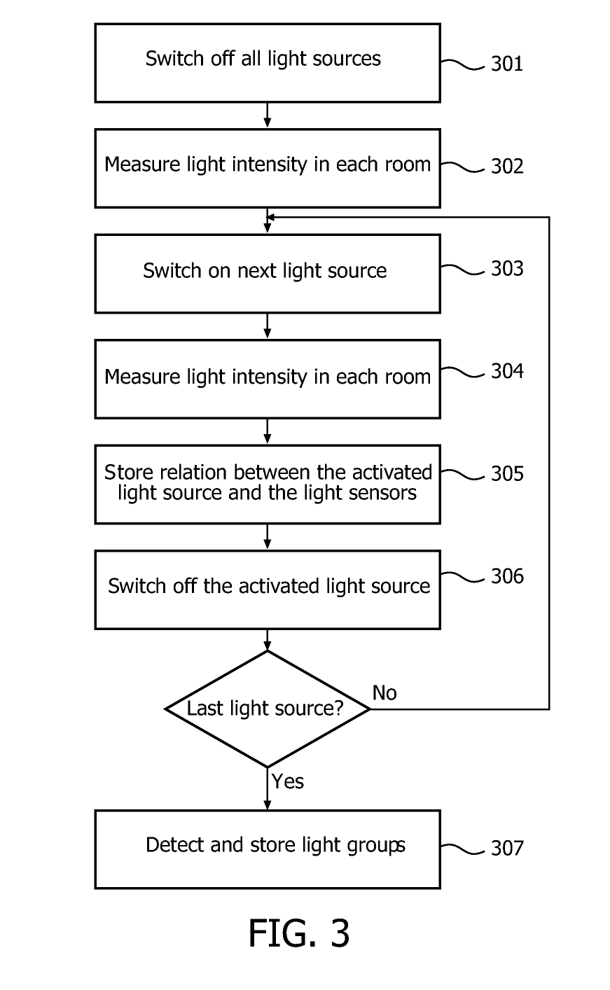

An automatic commissioning procedure according to an embodiment of the invention will now be described with reference to FIG. 2 and FIG. 3.

FIG. 2 schematically illustrates the lighting control system 100 in FIG. 1, installed in an environment with three separate rooms 201-203. The central controller 102 is here mounted in the ceiling in one of the rooms. Here, each room has two light sources 104a-f, one light sensor 106a-c, and one triggering device 108a-c. Each triggering device is here arranged next to its respective light sensor. The relations between the light sensors and the triggering devices (i.e. which light sensor and which triggering device that belong to the same room) can be fixed during wiring. Here, light sensor 106a is associated with triggering device 108a, light sensor 106b is associated with triggering device 108b and light sensor 106c is associated with triggering device 108c. To facilitate installation these relations may be made intuitive by having the connection point on the central controller marked with common color for related light sensors and trigger devices. Moreover, each light sensor and its associated triggering device may be arranged in the same housing, and connected to the central controller by a common wire that is connected to the central controller by a common plug, whereby the relation between the light sensor and the triggering device is made inherent.

It can be noted that explicit wiring of related light sensors and triggering devices is typically much less detrimental to the flexibility since in most cases there are more light sources than trigger devices. Also, the number of light sources per triggering device is not known in advance. Although the relations between light sensors and triggering devices are here fixed during wiring, it can, as an alternative, be stored in the memory of the central controller by explicit programming e.g. when the system is installed.

FIG. 3 is a schematic block diagram illustrating an automatic commissioning procedure according to an embodiment of the invention.

In step 301, all light sources are switched off by the central controller.

Then, in step 302, the central controller receives a measurement signal from each light sensor. Each measurement signal indicates the light intensity as registered by the light sensor. This light intensity is stored in the memory of the central controller as an initial light intensity value for that light sensor.

In step 303, one of the light sources is switched on by the central controller (while the other light sources remain switched off).

In step 304, the central controller receives a new measurement signal from each light sensor. For each light sensor, the current light intensity indicated by the new measurement signal is compared to the corresponding initial light intensity value stored in the memory of the central controller. If the difference between the current light intensity and the initial light intensity value exceeds a predetermined threshold value, this indicates that the light sensor registered light emitted by the activated light source and thus it is determined that the activated light source is in optical contact with the light sensor. For light sensors where the difference between the currently measured light intensity and the initial light intensity value does not exceed the predetermined threshold, the light source is considered not to be in optical contact with the light sensor.

The predetermined threshold value is here selected to reduce the influence of noise and other disturbances. As is recognized by a person skilled in the art, the value of the predetermined threshold will depend a variety of factors, such as, background light (e.g. daylight), the sensitivity of the light sensor, the intensity of the light emitted by the light sources, and the distance between the light sensor and the light sources. To improve the accuracy of the auto-commissioning procedure it is beneficial when the window shutters are down or in some other way it is taken care that minimal external light interferes with this self learning procedure.

In step 305, the relationships between the activated light source and each light sensor are stored in the memory of the central controller (i.e. it is stored whether the light source is in optical contact with the light sensor or not).

In step 306, the activated light source is switched off.

Steps 303 to 306 are then repeated for the other light sources until the relations between the light source and the light sensors have been checked for all light sources.

Then, in step 307, light groups are determined. In this embodiment, all light sources that are in optical contact with a specific light sensor will form a light group. The light groups are stored in the memory of the central controller, thereby enabling the central controller to synchronously control all light sources in a specific light group.

For the lighting control system installed in the environment in FIG. 2, the resulting relationships between the light sources and the light sensors are indicated in the table below, where a “X” indicates that the light sensor and the light source are in optical contact and thus are in the same room.

| | 106a | 106b | 106c |
|---|---|---|---|
| 104a | X | | |
| 104b | X | | |
| 104c | | X | |
| 104d | | X | |
| 104e | | | X |
| 104f | | | X |

Thus, here light sources 104a-b will be included in a first light group associated with room 201 and triggering device 108a, light sources 104c-d will be included in a second light group associated with room 202 and triggering device 108b, and light sources 104e-f will be included in a third light group associated with room 203 and triggering device 108c.

Furthermore, the results of the auto commissioning may also be readable through the user interface in order to allow for manual modification. For example, a user may combine the first light group and the second light group to always operate together, or one to trigger also the other. This may be convenient, for example, when the light groups are adjacent to each other and there are frequently people changing between the areas covered by the first and second light groups.

Also, if no relationships between light sources and light sensors can be found (e.g. because the level of daylight is so high that a change in light intensity as the light sources are switched on cannot be detect) the central controller 102 may automatically go to a non-commissioned mode where all light sources 104 a-f are operated synchronously by any of the triggering devices 108a-c. According to another embodiment, the lighting control system may be configured to detect whether a movable partition wall, used to divide a room into two smaller rooms, is present or not.

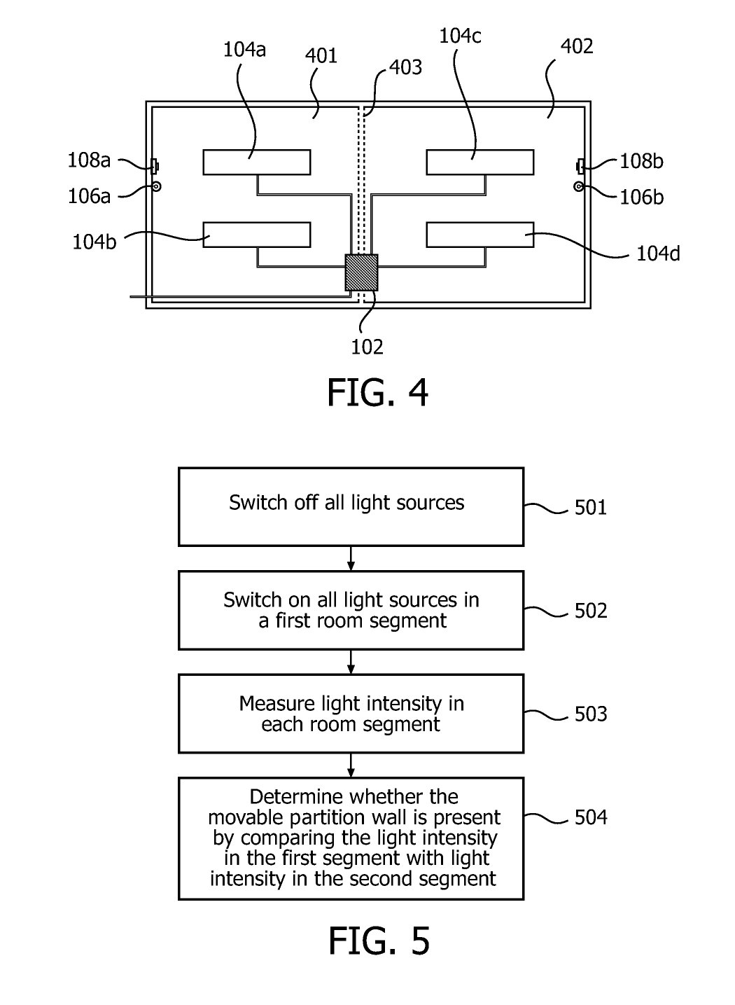

FIG. 4 schematically illustrates a lighting control system as described above installed in a room that can be divided into two separate rooms 401,402 by a movable partition wall 403. Here, if the movable partition wall is open, each triggering device 108a,b should control light sources in both room segments 401,402, whereas, if the movable partition wall is closed, each triggering device 108a,b should only control the light sources arranged in the same room segment as the triggering device (i.e. triggering device 108a should control light sources 104a-b, whereas triggering device 108b should control light sources 104c-d).

Here, the presence of the partition wall 403 can be detected as described below in relation to FIG. 5.

First, in step 501, all light sources are switched off by the central controller.

Then, in step 502, all of the light sources 104a-b in the first room segment 401 are switched on by the central controller (while the light sources 104c-d in the second room segment 402 remains switched off).

In step 503, the central controller receives a measurement signal from each light sensor 106a-b. Each measurement signal indicates the light intensity as registered by the light sensor.

In step 504, the central controller compares the light intensity registered by the light sensor 106a in the first room segment 401 with the light intensity registered by the light sensor 106b in the second room segment 402. If the difference in light intensity exceeds a predetermined threshold value it is determined that the movable partition wall 403 is closed, otherwise it is determined that the movable partition wall 403 is open. As is recognized by a person skilled in the art, the predetermined threshold value will depend on the circumstances. An advantage with the above described procedure is that no specific switch is required that reports whether the movable partition wall is open or closed.

According to another embodiment, the presence of the movable partition wall can be detected by switching on all light sources in both room segments and comparing the light intensity registered by the light sensor 106a in the first room segment 401 to an expected light intensity value stored in the memory of the central controller. If the registered light intensity exceeds the expected light intensity value, the central controller determines that the movable partition wall is open and otherwise it is considered to be closed. The expected light intensity value can e.g. be determined during installation by measuring the light intensity while the movable partition wall is open and all light sources are switched on. As an alternative, the central controller may first switch on all light sources in the first room segment (while the light sources in the second room segment are switched off), and then switch on all light sources in the second room segment (while the light sources in the first room segment are switched off), and measure whether the light level registered by the light sensors in each segment remains above the threshold in both cases. If so, this indicates that the moveable partition wall is open. This may provide a better accuracy by reducing the saturation effects in the light sensor that may arise when there is a lot of light around.

According to yet another embodiment, the central controller is configured to identify individual light sources by means of an identifier generated by intensity modulation. To generate the identifier light emitted by the light source can be modulated in intensity or color or spectral content over time. The intensity modulation may preferably be done with such subtle differences and/or so high modulation frequencies that the variations are not perceptible to the human eye. The identifier is registered by the light sensor, and can then be decoded by the central controller. Furthermore, the modulation schemes can be selected to use orthogonal patterns that allow detection of each individual identifier even when all light sources are synchronously modulated. An advantage is that multiple light sources can be switched on synchronously during the auto-commissioning procedure since identifiers of light sources in the same room can be read in parallel.

According to yet another embodiment, the central controller is configured to identify various types of light sources by measuring spectral contribution, white point and/or colour point. This can be achieved by using heuristics to identify various types of light sources based on the specific spectra or typical run up colour point deviations that typically occurs before the light source temperature is stabilized. For example, fluorescent tubular lamps tend to start with low flux, which gradually increase as the temperature in the lamp gets higher. There is also a change in colour point as the lamp gets warmer. This run-up behaviour allows fluorescent tubular lamps to be distinguished from halogen lamps which are always warm white and do instantly start with full flux. Furthermore, for HID based lamps the run-up is even longer, typically about 30 seconds. Thus, HID based lamps also have a characteristic run up behaviour. Another characteristic feature of the HID based lamp is a very long restrike time (some minutes) when they have been switched off and should be restarted directly.

A lighting policy is often created as a part of the commissioning procedure. The lighting policy typically gives different light sources different roles, for example, the lighting policy may decide which light sources should continue to run even when no person is present. The type of role is typically associated with the type of light source in question. For example a lighting policy may prescribe that:
HID based lamps, which are very efficient, should remain switched on due to their very slow restart, typically about 10 minutes, except when daylight is so high that no illumination is required;
fluorescent tubular lamps should be switched off after a long delay if no one is present,
halogen lamps, which easily restarts and consume a lot of power, should be switched off with a short delay when no one is present.

Thus, by identifying the type of light source, the central controller can automatically create a light group that only includes a specific type of light source. The central controller may then allocate a set of pre-programmed instructions (e.g. how it should react on presence detection and how long the presence delay should be) to the resulting light group.

According to another embodiment, different type of light sources may be identified based on a certain flux variation frequency (50/100 HZ or kHz range) that arise due to the lamp driver that is used.

According to yet another embodiment, the central controller monitors the change in light intensity as light sources are switched on and off during normal operation (i.e. not only during the auto-commissioning procedure). The central controller then compares the detected change in light intensity to a value stored in the memory that describes the expected change in light intensity. This allows changes in room layout and/or defective light sources to be automatically detected. The central controller may then schedule an auto-commissioning procedure, e.g. during next night.

The invention has mainly been described above with reference to a few embodiments. However, as is readily appreciated by a person skilled in the art, other embodiments than the ones disclosed above are equally possible within the scope of the invention, as defined by the appended claims.

1. A system for controlling a plurality of light sources by means of light groups, wherein each light group synchronously controls a subset of said plurality of light sources, said system comprising:
a central controller;
a plurality of light sources wired to said central controller; and
a light sensor wired to said central controller; wherein said central controller is configured to:
receive a measurement signal from said light sensor;
based on the received measurement signal, determine a subset of light sources that are in optical contact with said light sensor; and
include the subset of light sources in a light group associated with said light sensor.

2. A system according to claim 1, wherein said subset of light sources includes all light sources that are in optical contact with said light sensor.

3. A system according to claim 1, wherein the central controller is configured to identify a specific light source by a light property of the light emitted by that specific light source.

4. A system according to claim 3, wherein said light property is a variation in light intensity.

5. A system according to claim 4, wherein said central controller is configured to switch on and off the light source to achieve said variation in light intensity.

6. A system according to claim 5, wherein said central controller is configured to sequentially switch on and off each light source, while the other light sources remains switched off.

7. A system according to claim 3, wherein said central controller is configured to identify individual light sources by means of intensity modulation.

8. A system according to claim 1, wherein said subset of light sources only includes light sources of a specific type.

9. A system according to claim 1 wherein said central controller is configured to identify a specific type of light source by means of at least one light property selected from the group of spectral contribution, colour, or white point.

10. A system according to claim 1, wherein said light sensor and a triggering device are arranged in a combined housing.

11. A system according to claim 10, wherein said triggering device is a manual switch.

12. A system according to claim 1 wherein said central controller is configured to automatically trigger a procedure for creating light groups at a predetermined occasion.

13. A system according to claim 12, wherein said procedure for creating light groups is delayed until a light level registered by the light sensor is below a predetermined value.

14. A system according to claim 12, wherein said procedure for creating light groups is delayed until a predetermined time has elapsed during which no person has been detected by a movement detector.

15. A system according to claim 1 wherein said central controller has a pre-programmed default light group that includes all light sources that are connected the central controller.
